(19) United States
(12) Patent Application Publication
(10) Pub. No.: US 2009/0032520 A1
(43) Pub. Date: Feb. 5, 2009

(54) Ribbon Based Heating Apparatus and Method

(76) Inventor: Charles E. Cronn, Union, WA (US)

Correspondence Address: K&L Gates LLP, 618 W. Riverside, Suite 300, SPOKANE, WA, 99201-0628, US

(21) Appl. No.: 12/037,030

(22) Filed: Feb. 25, 2008

Related U.S. Application Data
(60) Provisional application No. 60/891,453, filed on Feb. 23, 2007.
(60) Provisional application No. 61/030,807, filed on Feb. 22, 2008.

(51) Int. Cl. H05B 3/64

(52) U.S. Cl. 219/211; 219/529

(57) ABSTRACT

A heating apparatus comprising a ribbon element, a power source and related components. The heating apparatus can be designed, retrofitted or manufactured into articles of clothing or equipment such as gloves, vests, jackets, shirts, pants, socks, insoles, mitts, handwarmers, seats and other common articles. A ribbon element comprises one or more conductive wires woven into a carrier strip. Various wiring configurations can desirably adjust the resistance of the ribbon element thereof. Methods of manufacture and use are disclosed in conjunction with the heating apparatus.

### CROSS REFERENCE TO RELATED APPLICATIONS

This application claims the benefit of U.S. Provisional Application No. 60/891,453 filed Feb. 23, 2007, titled “Heated Glove With Textile Based Ribbon Heating Apparatus” and whose entire contents are hereby incorporated by reference. This application also claims the benefit of U.S. Provisional Application No. 61/030,807 filed Feb. 22, 2008, titled “Ribbon Based Heating Apparatus” and whose entire contents are hereby incorporated by reference.

### TECHNICAL FIELD

Embodiments of the present invention pertain generally to heating apparatus that can be incorporated into articles of clothing or equipment. More particularly, embodiments of the present invention are directed to the design, manufacture and use of an improved ribbon heating element.

### BACKGROUND

While there is a substantial amount of prior art directed at heated clothing and equipment to overcome cold environmental conditions in various applications, few if any of these technologies have been embraced by the marketplaces. Such prior art ranges in concept from gel packets causing exothermic chemical reactions to pre-heated units placed into clothing articles to traditional electric heating devices. More particularly, prior art relating to electric heating devices incorporated into clothing tends to be bulky, heavy and inflexible—thus cumbersome and uncomfortable to wear. It is no surprise that such devices have not been incorporated into everyday clothing and equipment products such as ski gloves, hunting vests or the like.

Typically, such the heating elements found in prior art heated clothing are manufactured using relatively noticeable wiring and inflexible materials (e.g. inflexible wiring of a gauge causing inconvenience). Due to the discomfort and inconvenience of such prior art heating devices, such heating devices are typically only incorporated into clothing or equipment where the critical necessity outweighs the discomfort or inconvenience, (e.g. long term exposure or extreme cold conditions). Even so, such heating devices remain uncomfortable to wear on a regular basis and are prone to fatigue as the heating elements are repeatedly folded, stretched or twisted in the ordinary course of wear and tear.

Similarly, the heating devices industry has also evidenced a lack of technology in providing sufficient portable power supplies given an acceptable weight. As the demand for more heat output or the duration of a given heat output increases, more electric power is required to be supplied from a given electric power source. To date, one of the other reasons that prior art heating devices have not been incorporated in mainstream articles of clothing or equipment, is the limited electric power capacity for their weight. Basically, the quantity of heat generated from the potential electric power stored in prior art batteries simply has not justified the burden of additional weight and inconvenience of the batteries. By way of example, while a snow skier may desire to utilize a pair of heated gloves on a cold day, that skier probably wouldn't be willing to carry around a heavy battery, nor incur the expense of expending a bag full of portable batteries (e.g. alkaline batteries) to keep their body (e.g. fingers, toes, etc.) warm during the course of the day. Thus, it is justifiable, given the lack of technology exhibited in the prior art, why society has evidenced a distinct absence of skiers wearing heated gloves on the slopes. Not unlike the ski community, other communities or activities taking place in cold environments have not witnessed the mainstream acceptance of heated articles of clothing.

Part of this challenge becomes the level of expertise needed to feasibly design and manufacture a heated device having the performance to perform its function, the lightweight and comfort features necessary to be transparent when compared to another article of clothing or equipment, and to be able to be designed, manufactured and supported at a reasonable cost. To design such a new advanced electrically heated article of clothing or equipment, one must become an expert in many fields: material science, electronic wiring and equations, battery designs, power calculations, clothing manufacturing, insulation methods, product safety considerations, textile manufacturing processes as well as other fields. Thus, due to the performance, comfort, cost, support and required talent to be combined into a single product with so many components and variables at play—no heating articles of clothing or equipment have broken into widespread use.

Therefore, an urgent need exists in the clothing and equipment industries to provide a heating apparatus capable of being incorporated into various manufactured articles that is of high performance, minimal bulk, minimal weight, increased flexibility, extended heat generation duration, increased durability and ease of support when compared to the prior art.

Such a heating apparatus would preferably also be capable of being designed, retrofitted and manufactured in a standardized manner. Preferably, such standardized components could also be assembled using common textile industry machines rather than requiring custom fabrication equipment and manual labor as evidenced in the prior art.

### SUMMARY

Embodiments of the present invention are directed toward an improved ribbon element serving as a standardized heating device that can be incorporated into existing or new articles of clothing and equipment. The improved ribbon element evidences a significant advancement of heating technology in that embodiments of the present invention (e.g. heated gloves, heated vests, etc.) are virtually indistinguishable in feel, weight and flexibility from ordinary non-heated articles of clothing (e.g. ordinary gloves, ordinary vests, etc.). Further such embodiments, due to the nature and flexibility of the ribbon element, are capable of significantly longer longevity and durability when compared to prior art heating devices. As such, the incorporation of the ribbon element heating apparatus into existing and new articles of clothing renders a superior product available to those regularly exposed to cold environmental conditions.

Other embodiments of the present invention are directed toward standard heating panels comprising one or more ribbon elements that can be incorporated on a modular basis into various articles of clothing or equipment. By way of example, one or more 7 volt heating panels can be placed into a glove, a vest, pants, garment system or other articles of clothing or equipment, all utilizing a standard power source designed for use in conjunction with the 7 to 7.5 volt heating panels.

Further embodiments of the present invention are directed toward the method of design and manufacture of such a heating apparatus and ribbon element.

Various options and approaches of embodiments of the invention are also discussed throughout the technical disclosure, including additional components, characteristics and aspects that enhance the performance of various embodiments. It is understood that while heated articles of clothing (e.g. gloves, vests) and heated articles of equipment (e.g. sporting goods, vehicle components) are exemplary applications used to describe specific details of a best mode of practice of the invention, the presently disclosed invention contemplates other embodiments not necessarily disclosed within the confines of the present examples.

### BRIEF DESCRIPTION OF THE DRAWINGS

Embodiments of the invention are illustrated by way of example, and not by way of limitation, in the figures of the accompanying drawings and in which like reference numerals refer to similar elements, wherein:

FIG. 1 is a top view of a ribbon heating apparatus within a heated glove according to an embodiment of the invention.

FIG. 2 is a top view of a ribbon heating apparatus according to an embodiment of the invention.

FIG. 3A is a top view of a ribbon element according to an embodiment of the invention.

FIG. 3B is a top view of the ribbon element of 3A with each end thereof connected to a conduit according to an embodiment of the invention.

FIG. 3C is a top view of the ribbon element of 3B illustrating flexibility of the ribbon element according to an embodiment of the invention.

FIG. 4A is a view of prior art wire utilized in prior art heating devices.

FIG. 4B is a view of an improved conductive wire having a high strand count according to an embodiment of the invention.

FIG. 4C is a view of an improved conductive wire having an exceptionally high strand count according to an embodiment of the invention.

FIG. 5A is a top view of a ribbon element comprising of three conductive wires according to an embodiment of the invention.

FIG. 5B is a top view of a ribbon element comprising of four conductive wires according to an embodiment of the invention.

FIG. 5C is a top view of a ribbon element comprising of five conductive wires according to an embodiment of the invention.

FIG. 6A is a top view of a ribbon element comprising an alternate wiring scheme.

FIG. 6B is a top view of a ribbon element comprising an alternate wiring scheme.

FIG. 6C is a top view of a ribbon element comprising an alternate wiring scheme.

FIG. 7A is a cut-away end view of a heated glove according to an embodiment of the invention.

FIG. 7B is a close-up cut-away end view of a heated glove according to an embodiment of the invention.

FIG. 8 is a cut-away top view of a heated footbed article according to an embodiment of the invention.

FIG. 9A is a perspective view of a heated sock according to an embodiment of the invention.

FIG. 9B is a perspective view of a heated sock according to an embodiment of the invention.

FIG. 10 is a front view of a heated jacket according to an embodiment of the invention.

FIG. 11 is a front view of a heated clothing system and a plurality of articles of heated clothing according to an embodiment of the invention.

FIG. 12A is a top view of a heated mitt according to an embodiment of the invention.

FIG. 12B is a top view of a heated handwarmer according to an embodiment of the invention.

FIG. 13A is a perspective view of a heated seat on an all terrain vehicle.

FIG. 13B is a close-up perspective view of a heated seat for an all terrain vehicle.

### DETAILED DESCRIPTION OF PREFERRED EMBODIMENTS

In the following description, for the purposes of explanation, specific details are set forth in order to provide a thorough understanding of the invention. However, it will be apparent that the invention may be practiced without these specific details. In other instances, well-known structures and devices may be depicted in block diagram form in order to avoid unnecessary obscuring of the invention. Section titles and references appearing within the following paragraphs are intended for the convenience of the reader and should not be interpreted to restrict the scope of the information presented at any given location. Various aspects and features of example embodiments of the invention are described in more detail hereinafter in the following sections: (i) Functional Overview, (ii) Ribbon Element, (iii) Applications Of A Ribbon Element, (iv) Case Examples and (v) Conclusion.

### Functional Overview

The improved ribbon element heating apparatus disclosed in the present technical disclosure solves various aforementioned shortcomings and problems posed by the prior art. More particularly, heated articles (e.g. gloves, clothing, seats, etc.) incorporating (e.g. retrofitting, manufacturing or placing) the improved ribbon element heating apparatus evidence one or more of the advantages of light weight, flexibility, comfort, durability, longevity, efficiency of manufacture and ease of support not found in the prior art.

For the purposes of the present disclosure, various embodiments directed toward heating apparatus will be discussed at length. However, such discussion should not be construed to limit the scope of the present disclosure and present invention to only heated apparatus. It is noted that the ribbon element, while described herein for heating purposes, can also be utilized in a number of other embodiments ranging from power transmission functions or data transmission applications.

At the core level of theory, embodiments of the present invention primarily comprise a ribbon element wherein electricity is transmitted through the ribbon element thereby generating heat. Such a ribbon element namely comprises one or more conductive wires woven within a flexible carrier to form a flexible ribbon allowing the transmission of electricity and the generation of heat. The flexible ribbon element can be utilized in the manufacture of heated articles, such as heated articles of clothing (e.g. gloves, shirts, pants, socks, shoes, hats, uniforms, etc.) or heated articles of equipment (e.g. sports mitts, sports hand warmers, portable seat pads, vehicle seats, etc.). The flexible transmission element can also be utilized for other purposes, as desired, for the manufacture of articles of clothing or articles of equipment for the transmission of data rather than heat generation.

The unique one or more conductive wires are each comprised of a bundle of conductive strands or fibers. These bundles can be fabricated from high count strand stainless steel, stainless steel fibers, other metallic strands or fibers, micro fiber or other conductive fibers such as metallic plated or metallic bearing fibers. The conductive content of metallic plated or metallic bearing textile fibers can be any conductive or semi conductive metal (copper, nickel, silver, etc.) on or intermingled with a textile base (textile carriers can include nylon, polyester, cotton, etc.)

The bundles of strands or fibers forming conductive wires are woven into a carrier strip to form a ribbon element. For purposes of this disclosure, a strand and a fiber are equivalent, though “strands” are usually referred to in wires having a lower count of strands than other wires having a higher count of “fibers.” The conductive wires (bundles of strands or fibers) can be either coated (for protective or insulation purposes) or non-coated. The ribbon element and any related components thereof (e.g. conduit, power supply, etc.) constitute an apparatus that acts as a heating element or an element for the transmission of electricity (e.g. power transmission or data transmission).

The number of strands or fibers in each bundle thereby comprising a conductive wire can vary depending upon the embodiment or application desired. Likewise, the number of conductive wires woven into a carrier strip can vary depending upon the embodiment or application desired.

In preferred embodiments it is advantageous to coat the bundles of fibers with a coating such as PTFE (e.g. Tefzel), PVC or other durable material. While a coating provides electrical insulation of the conductive wires from the environment, some degree of electrical insulation is also fortuitously provided by the carrier strip itself, and can be varied by changing the weave pattern. The carrier strip can preferably secure the conductive wires (and thus the bundles of fibers as well) in place and discourage contact between adjacent conductive wires.

In preferred embodiments designed for the generation of heat, electricity is transmitted through the conductive wires through the length of the ribbon element. The design and length of the ribbon can be determined and standardized to match a suitable power source, thereby optimizing performance of the heating apparatus. Various wiring schemes can be utilized to optimize the resistance of the ribbon element to match the power source voltage. Control mechanisms configured within or in conjunction with the power source can also be utilized to selectively control the amount of electricity transmitted through the ribbon element.

The manufacturing process of the ribbon element and heating apparatus also represents a significant advancement of the art, as heating apparatus can be manufactured in a standardized, simplified process not yet witnessed in the art. For application into articles of clothing or equipment, whether a retrofit or a new article, the ribbon element and related components are thereafter sandwiched, sewn, attached or otherwise incorporated into the existing physical structure of the article. As preferred embodiments utilize standardized heating panels and power sources, if a ribbon element or other component fails, the failed component can be readily replaced with a like standard unit.

A comprehensive and detailed examination of preferred embodiments of the present invention will now be addressed in the following sections, namely discussion of ribbon elements, power sources, heating apparatus, heated articles and the manufacture thereof.

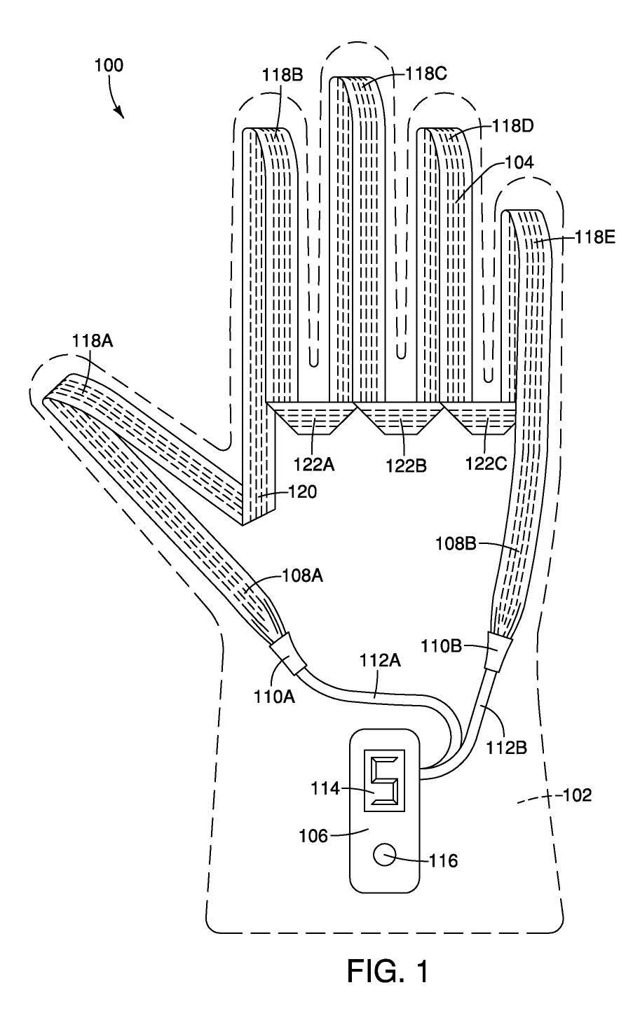

FIG. 1 is a illustration of a heated article 100, namely a glove 102 (depicted as a dotted line) with a ribbon element 104 coupled to a power source 106. As illustrated, a first end 108A of ribbon element 104 is electrically coupled to a conduit 112A utilizing a connector 110A, and a second end 108B of ribbon element 104 is coupled to a conduit 112B utilizing a connector 110B. Conduits 112A and 112B are electrically coupled to power source 106, thereby providing electronic communication between power source 106 and ribbon element 104. In the configuration as illustrated, ribbon element 104 is secured within the glove 102 along the top of each of the fingers and thumb of the glove 102, with various folds 118A-E, 120 and 122A-C configured in the ribbon element 104 to allow such placement. More particularly, fold 118A allows one portion of the ribbon element 104 to reach the end of the thumb (not referenced) and proceed backward at or nearly at a 180-degree direction and onward toward the index finger (not referenced). As illustrated, it is highly preferable to fold back the ribbon element 104 on itself rather than attempt to force the ribbon element 104 to turn at a sharp angle within its own plane. Likewise, folding the ribbon element 104 back upon itself at fold 120 as shown is a preferred method of changing the direction of the ribbon element 104, rather than subject the ribbon element 104 to unbalanced twisting or bunching within its own plane. Similarly, in folds 122A, 122B and 122C, the ribbon element 104 can be configured to create parallel and desirably spaced longitudinal areas that are covered by the ribbon element 104.

As shown, power source 106 further comprises a switch 116 (such as a pushbutton as illustrated) to control the transmission of electricity through ribbon element 104. Any conventional switch technology or electrical limitation device (e.g. sliding switches, rotary switches, digital switches, timer switches, diodes, etc.) can be utilized for switch 116 to provide a desired constant, pulsed or periodic, variable or non-variable, transmission of electricity to the ribbon element 104.

Power source 106 can also be configured to comprise a meter 114 (such as an LED number as illustrated) to indicate the status of the availability of power in the power source, the status of the amount of electricity being transmitted or other desired information to the user of the heating apparatus. For example, as illustrated by meter 114, the number “5” can be configured to indicate a remaining power available of 50%. If desired, such a “5” can also be configured to indicate a power setting (amount of transmission of electricity) of 5 on a given scale relating to a variable power setting.

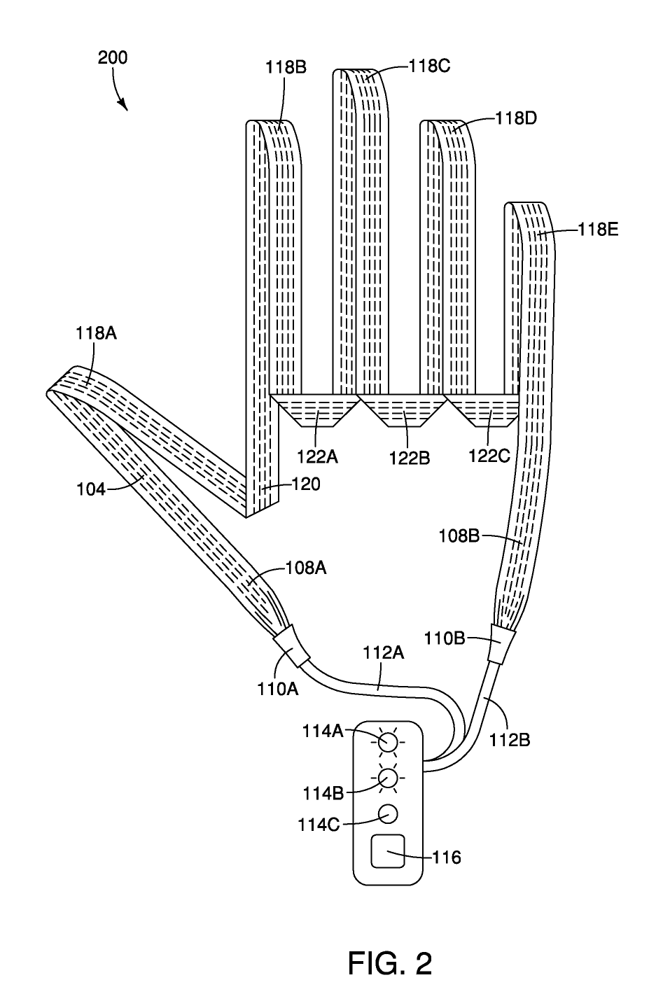

Turning to FIG. 2, a heating apparatus 200 is illustrated, similar to heating apparatus 100 in FIG. 1 with similar elements as discussed above, (glove 102 omitted). However, the heating apparatus 200 evidences an alternate metering configuration comprising of a first meter 114A, a second meter 114B and a third meter 114C. As depicted, first meter 114A and second meter 114B are illuminated whereas third meter 114C is not illuminated. Depending upon the desired application, meters 114A, 114B and 114C can be configured to convey the power availability (e.g. battery at ⅔ power), the amount of electricity being transmitted through the ribbon element 104 (e.g. the current heat setting) or other pertinent information to the user of the heating apparatus 200. Each of the meters 114A, 114B and 114C can also be configured to represent independent information (e.g. power on status, power left status, power charging status, etc.)

Thus having provided a brief introduction of the basics of a preferred heating apparatus, the present disclosure will now examine further aspects of the ribbon element, the power source and related elements and manufacture thereof in greater detail.

### Ribbon Element

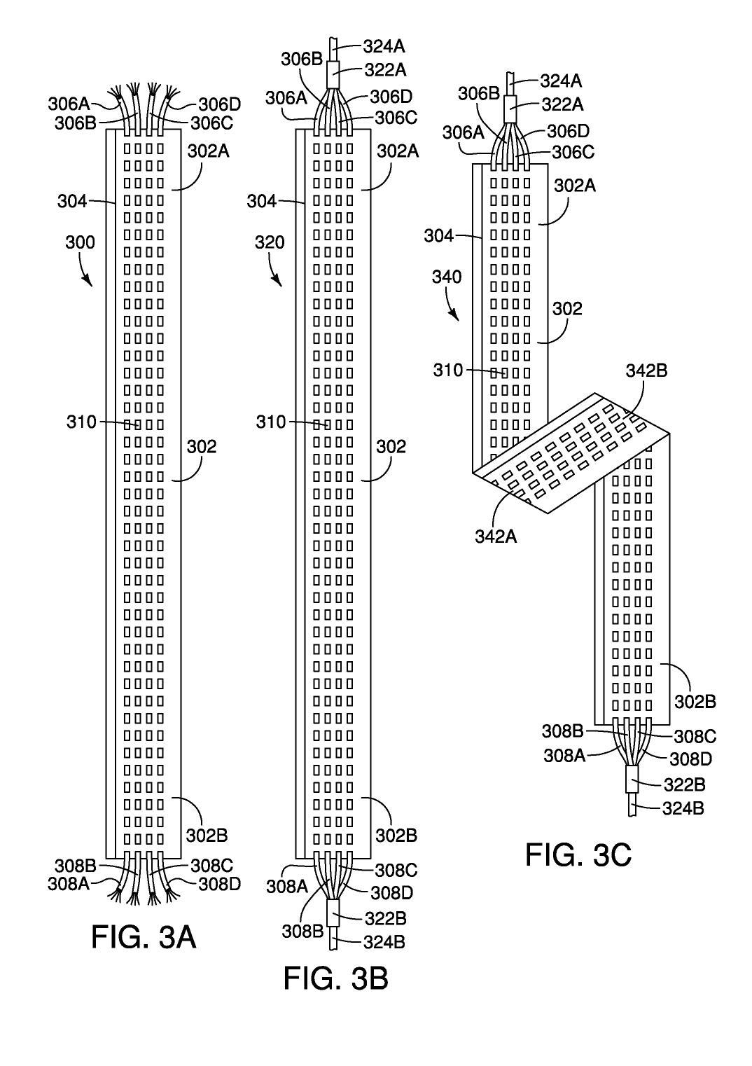

FIG. 3A illustrates a ribbon element 300 having four conductive wires, namely a first conductive wire having ends 306A and 308A, a second conductive wire having ends 306B and 308B, a third conductive wire having ends 306C and 308C and a fourth conductive wire having ends 306D and 308D. The conductive wires are woven into carrier strip 302, with a first end 302A of the carrier strip 302 in the proximate area of ends 306A, 306B, 306C and 306D, and a second end 302B of the carrier strip 302 in the proximate area of ends 308A, 308B, 308C and 308D.

It is preferable that carrier strip 302 comprise a flexible and durable material. Moreover, it is advisable to use a material for carrier strip 302 that is capable of being manipulated by textile industry standard machines. Examples of such a carrier strip 302 material are nylon and polyester, although more exotic materials such as Nomex, Kevlar or other specialty materials can be utilized.

For ease of manufacturing identification and positioning of a ribbon element 300, it is preferable to configure the carrier strip 302 with a marker 304 along one or more longitudinal edges of the carrier strip 302. In this manner, marker 304 can readily identify any twists, folds or configured polarity of ribbon element 300.

Typically in the manufacture of a ribbon element 300, regularly spaced portions of the outside of the conductive wires remain exposed along the length of the carrier strip 302 during the weaving process, as depicted by the numerous visible segments 310 in the illustration. Of course, if the conductive wires are coated as in preferred embodiments, then the coating of the conductive wires would be visible in visible segments 310 (rather than the inner conductive strands/fibers).

While embodiments of the present invention as disclosed reflect that conductive wires have been woven into a carrier strip resulting in a pattern of visible segments 310, it is possible to fabricate ribbon element 300 in other securing configurations such as sandwiching the conductive wires between two carrier strips (not shown), adhering conductive wires to one face of a carrier strip (not shown) or other methods. Weaving conductive wires into a carrier strip (as depicted by ribbon element 300) has been found to be preferable over such other means of forming a ribbon element, though other such methods of securing one or more conductive wires to a carrier strip (e.g. adhesive, sandwiching, etc.) can be considered as equivalent to “weaving” one or more conductive wires to a carrier strip in the fabrication of a ribbon element. In that regard, a ribbon element having one or more conductive wires attached or in secure communication with a carrier strip is broadly construed as having the conductive wires “woven” into the carrier strip.

Turning to FIG. 3B, a ribbon element 320 similar to the ribbon element 300 of FIG. 1 is illustrated. Ends 306A, 306B, 306C and 306D are coupled to a conduit 324A utilizing a connector 322A. Likewise, ends 308A, 308B, 308C and 308D are coupled to a conduit 324B utilizing a connector 322B. While not illustrated, conduit 324A and conduit 324B are coupled to a power supply (not shown), thereby providing a circuit for electricity to be transmitted through ribbon element 320.

In some applications such as an article of clothing, there can be a high degree of linear stress on the conductive wires and electrical connectors. It is recommended to utilize sturdy and secure electrical connectors 322A and 322B (e.g. crimping devices, solder, etc.) to couple the conductive wires of the ribbon element 320 to conduits 324A and 324B.

To accomplish the both electrical and mechanical coupling of ends 306A, 306B, 306C and 306D to conduit 324A at the same time, one can implement a seamless (braised) butt splice electrical connector. To do so, the bundles of fibers are extracted or stripped from the ribbon and optionally twisted together. The bundles of fibers are then placed in the end of such a splice connector and mechanically crimped in place. This method secures the bundles of fibers and provides excellent electrical communication. Other methods such as spot welding and electrical resistance brazing may also be employed to create the connection and electrical communication to the conductors. The conduit 324A transmitting electric current (e.g. copper wire) is then connected to the opposite end of the connector 322A. While not illustrated, conduit 324A can also be inserted into the same end of connector 322A as the ends 306A, 306B, 306C and 306D, if desirable—which does not affect the electronic communication between conduit 324A and ends 306A, 306B, 306C and 306D. Similarly, ends 308A, 308B, 308C and 308D are secured and electronically coupled to conduit 324B with connector 322B. Thus, FIG. 3B depicts a ribbon element 320 capable of transmitting electricity between conduit 324A and conduit 324B.

FIG. 3C further depicts a ribbon element 340 similar to that of ribbon element 320 and elements thereof of FIG. 3B, wherein the ribbon element 340 further comprises a first fold 342A and a second fold 342B thereby illustrating the ability of ribbon element 340 to be folded, positioned or manufactured into a heated article (e.g. garment, equipment, etc.) as desired.

While the inherent physical nature of the carrier strip 302 provides some electrical insulation along with a coating on the conductive wires (not shown), at high voltages (e.g. 24-volt power source), it is advantageous in some configurations to place additional electrical insulation (not shown) between overlapping and adjacent portions of ribbon element 340 (e.g. at folds 342A and 342B). A first method of affording additional electrical insulation involves layering of fabric between overlapping or adjacent ribbon elements (not shown). Such a practice isolates ribbon element portions (and the conductive wires therein) from each other. Alternately, a heating element can be placed inside a fabric tube (not shown), which provides circumferential insulation along the ribbon element. This has the effect of providing two layers of fabric electrical insulation between folded, overlapping or adjacent ribbon element portions.

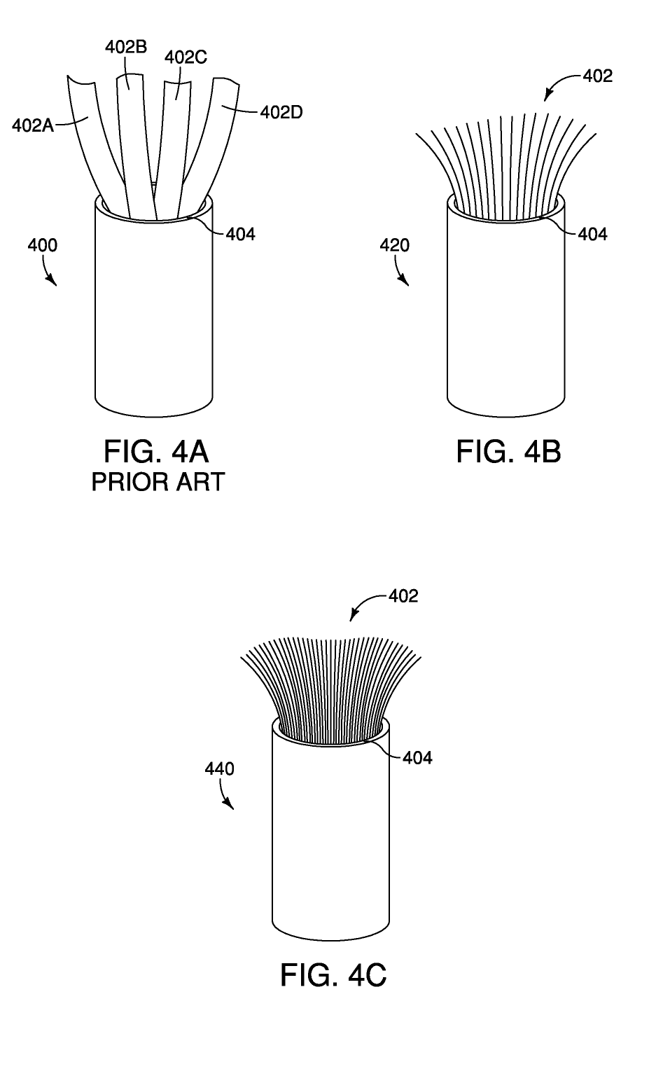

With respect to the design of bundles of fibers therein comprising a conductive wire, the prior art within the industry evidences primitive cable such as that depicted in FIG. 4A. A basic metal wire 400 is typically comprised of one or more individual strands 402A through 402D (e.g. four strands) with an outer sheath 404. While this style of metal wire 400 is capable of transmission of electricity, such a metal wire with few strands (four) as shown typically lacks desirable flexibility, fatigues rapidly and is difficult to weave into a carrier strip (not shown).

More particularly, with only a minimum number of strands present, the significant diameter of each strand makes the strand less flexible than its smaller diameter counterparts. It is well observed in the metallurgical arts that when a strand or fiber is bent around a corner having a radius of smaller diameter than the radius of the strand/fiber itself, significant fatigue occurs in the strand/fiber. Therefore, as the large strands 402A through 402D in FIG. 4A are bent or flexed to comply with environmental forces (e.g. an article of clothing being folded, twisted or stretched) the individual wire strands 402A through 402D significantly fatigue in comparison to smaller diameter strands/fibers having significantly smaller diameters.

By contrast, turning to FIG. 4B an improved conductive wire 420 is illustrated, namely comprised of a high number of fibers 402 (e.g. sixteen stainless steel fibers) surrounded by a coating 404 (e.g. PTFE). While electrical conductivity performance between the prior art metal wire 400 in FIG. 4A and the conductive wire 420 in FIG. 4B are relatively equivalent, the conductive wire 420 of FIG. 4B enjoys the benefit of increased environmental flexibility and resistance to environmental fatigue. These benefits are enjoyed by virtue of the smaller diameter of its fibers 402 in comparison to the larger strands 402A through 402D.

As depicted in FIG. 4C, when designing or selecting a conductive wire 440 to incorporate in a heating apparatus (not shown) it is therefore is desirable to increase the count of fibers 402 (e.g. over one hundred if feasible). Such embodiments of the conductive wire 440 demonstrate superior flexibility and resistance to fatigue when compared to the conductive wire 420 of FIG. 4B and the metal wire 400 of FIG. 4A. Notwithstanding ease of manufacture, the flexibility and resistance to fatigue enjoyed in conductive wire 440 results in comfort of use, durability, longevity and overall an advanced heating apparatus when compared to the prior art.

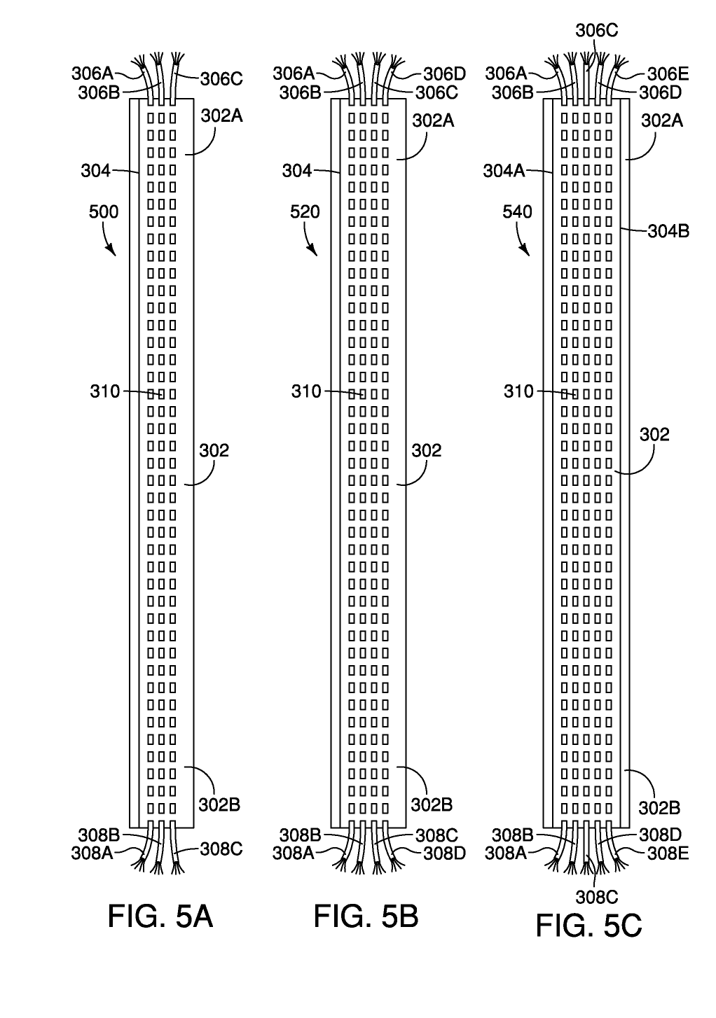

Turning to FIGS. 5A, 5B and 5C, various configurations of ribbon elements 500, 520 and 540, respectively, are illustrated. With respect to FIG. 5A, a ribbon element 500 is namely comprised of a carrier strip 302 with three conductive wires running from carrier strip portion 302A to carrier strip portion 302B having conductive wire ends 306A through 306C and ends 308A through 308C, respectively. Carrier strip 302 further comprises a marker 304 providing identification of positioning or configuration of the carrier strip 302.

Likewise, in FIG. 5B, ribbon element 520 comprises a fourth conductive wire having ends 306D and 308D running from carrier strip ends 302A and 302B, respectively. Similarly, in FIG. 5C, ribbon element 540 comprises a fifth conductive wire having ends 306E and 308E running from carrier strip ends 302A and 302B, respectively. As illustrated, ribbon element 540 further comprises two markers 304A and 304B rather than a single marker 304 as shown in the ribbon element 500 in FIG. 5A and the ribbon element 520 in FIG. 5B.

Typically, electricity is transmitted through all conductive wires in a given ribbon element similar to the configuration of ribbon elements 320 and 340 in FIGS. 3B and 3C, respectively. In such a configuration, the bundles of fibers are all utilized as a parallel circuit along the longitudinal length of a given ribbon element.

Since the number of conductive wires is different between the ribbon elements 500, 520 and 540 in FIGS. 5A, 5B and 5C, respectively, each of the ribbon elements 500, 520 and 540 evidence different electrical properties (e.g. resistance, minimum and maximum recommended current and other attributes). For purposes of comparison in the next proximate paragraphs, the ribbon element 520 of FIG. 5B shall be considered a control having certain electrical attributes for comparative analysis. By way of example, it is assumed that all three ribbon elements 500, 520 and 540 would be configured in a parallel circuit configuration where all bundles of fibers are in electrical communication with one another at each of the ends 302A and 302B, (similar to ribbon element 320 in FIG. 3B and ribbon element 340 in FIG. 3C).

With respect to electrical resistance, ribbon element 500 will exhibit a higher electrical resistance than ribbon element 520, and ribbon element 540 will have a lower electrical resistance than ribbon element 520. Such considerations significantly affect the design and manufacture of an apparatus where either an optimal current or a constant current is desired. As the resistance of a given ribbon element affects the electric current through the ribbon element and heat generated by the ribbon element, it is a significant consideration to consider the length of the ribbon element, number of conductive wires in the ribbon element circuit and voltage of the power source when designing and manufacturing a heating apparatus for an article of clothing or article of equipment.

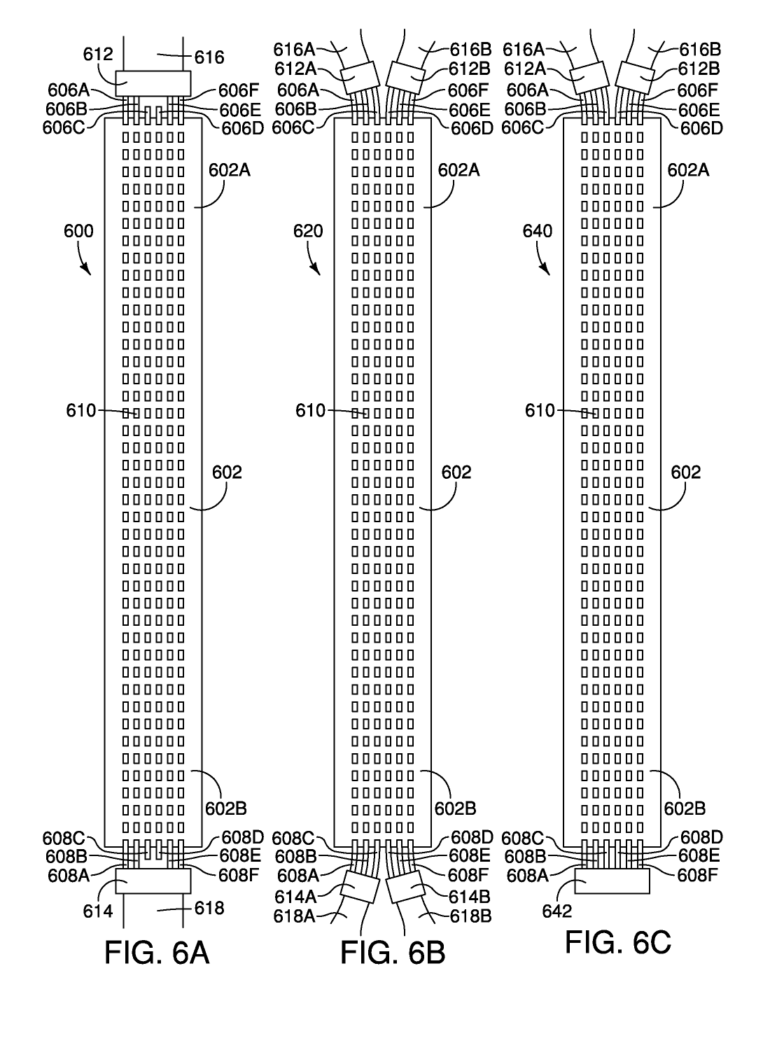

Certain configurations and wiring schemes of the ribbon element can also aid in optimizing an embodiment of the presently disclosed invention. FIGS. 6A, 6B and 6C illustrate alternate wiring schemes to adjust the electrical properties of a given ribbon element. In FIG. 6A, an alternate wiring scheme increasing electrical resistance (and thereby reducing electrical current) is illustrated by intentionally not utilizing all conductive wires in a fabricated ribbon element. As illustrated, a ribbon element 600 comprised of six conductive wires with ends 606A through 606F and ends 608A through 608F woven into portions 602A and 602B, respectively, of a carrier strip 602. As noted in earlier figures, portions of conductive wires can be visible and protrude from the carrier strip 602 as exemplified by portion 610. In many respects, ribbon element 600 is similar to ribbon element 320 of FIG. 3B in that four conductive wires are configured in a parallel circuit.

More particularly, in FIG. 6A ends 606A, 606B, 606E and 606F are coupled to conduit 616 by connector 612, while the corresponding ends 608A, 608B, 608E and 608F are coupled to conduit 618 by connector 614. It is noted that ends 606C, 606D, 608C and 608D of the conductive wires are not in electric communication with either connector 612 or conduit 618 rendering the middle two conductive wires of the ribbon element 600 unused. Such a configuration is helpful in circumstances where an increased resistance or decreased electric current through the ribbon element 600 is desired. However, because the six conductive wire ribbon element design can serve other configurations where five or six conductive wires are desirable to be used, such a ribbon element 600 as illustrated can be standardized across multiple designs, products or product lines for various applications. Thus, while ribbon element 600 is manufactured to comprise six conductive wires, only four of the conductive wires are utilized in the example provided by FIG. 6A. From a manufacturing standpoint, ribbon element 600 therefore can be configured to be equivalent in electrical properties to ribbon element 320 of FIG. 3B in all material respects (assuming length, conductive wire diameter/material and other attributes of the respective ribbon elements being equal).

Referring to FIG. 6C, another technique for increasing the resistance of a given ribbon element involves using a portion of the conductive wires to transmit electricity down one lateral side of the ribbon element and another portion of the conductive wires to transit electricity back up the opposite lateral side of the ribbon element. More particularly, a ribbon element 640 at portion 602A utilizes the three leftmost conductive wires having ends 606A, 606B and 606C (that are coupled to a conduit 616A with connector 612A) to transmit electricity down the left lateral side of ribbon 640 to portion 602B. In proximity to portion 602B of the ribbon element 640, a terminating connector 642 is used to couple ends 608A, 608B, 608C, 608D, 608E and 608F of the conductive wires together. Thus, with ends 606D, 606E and 606F coupled together to conduit 616B through connector 612B, the electricity is transmitted back up the rightmost side of ribbon element 640 completing a down-and-back run of the circuit. Thus, in the configuration as illustrated, the length of electricity being transmitted through a given ribbon element 640 can be effectively doubled (assuming sufficient conductive wires exist) by using separate portions of conductive wires in a serial circuit configuration.

Expanding this notion further, in FIG. 6B a ribbon element 620 can be configured to have multiple circuits along the same ribbon element 620. More particularly, ends 606A, 606B and 606C are coupled together to conduit 616A using connector 612A, and likewise ends 608A, 608B and 608C are coupled together to conduit 618A using connector 614A to form an independent three conductive wire circuit between conduit 616A and conduit 618A. Similarly, ends 606D, 606E and 606F are coupled together to conduit 616B using connector 612B, and likewise ends 608D, 608E and 608F are coupled together to conduit 618B using connector 614B to form an independent three conductive wire circuit between conduit 616B and conduit 618B. As can be appreciated, these independent circuits can be therefore independently configured and manipulated providing for additional functions (e.g. independent heating and power transmission circuits) or additional flexibility (e.g. different heating circuits).

As noted in the preceding paragraphs, it is highly preferable to optimize the wiring scheme (e.g. parallel, serial, unused portions or a combination thereof), length of the ribbon element desired, number of conductive wires and attributes of the power supply (e.g. voltage, wattage, etc.) to result in the desired result of transmission of electricity through the ribbon element.

In preferred embodiments, it is further advisable to configure a sensor (not illustrated) to automatically shut off the power supply under unsafe conditions. Such a sensor could be configured, as in current prototypes, to shut off the power supply when a temperature of 110 degrees is reached. Alternatively, such a sensor could also serve as a control to adjust the power output of the power source on a continuous basis.

As noted throughout the technical disclosure, diverse functions (e.g. heat generation, power transport or data transmission, etc.) can be performed by transmission of electricity through the ribbon element disclosed above. For purposes of describing a single best mode of practice under patent laws, various forms of apparatus for heat generation will be discussed in the following sections, which in no way should be construed to limit the scope of the foregoing invention to that of only heat generation.

### Applications of a Ribbon Element

While only certain examples of embodiments are discussed in detail below for brevity, there remains a diverse landscape of embodiments anticipated by the present invention. Therefore, it is further understood that the following examples are not limiting by nature, but rather specific examples where the disclosed apparatus can be applied to solve a problem or create an improved product.

While a number of heated articles of clothing or heated articles of equipment are capable of design and manufacture utilizing ribbon element designs, only a few of many are disclosed herein for brevity.

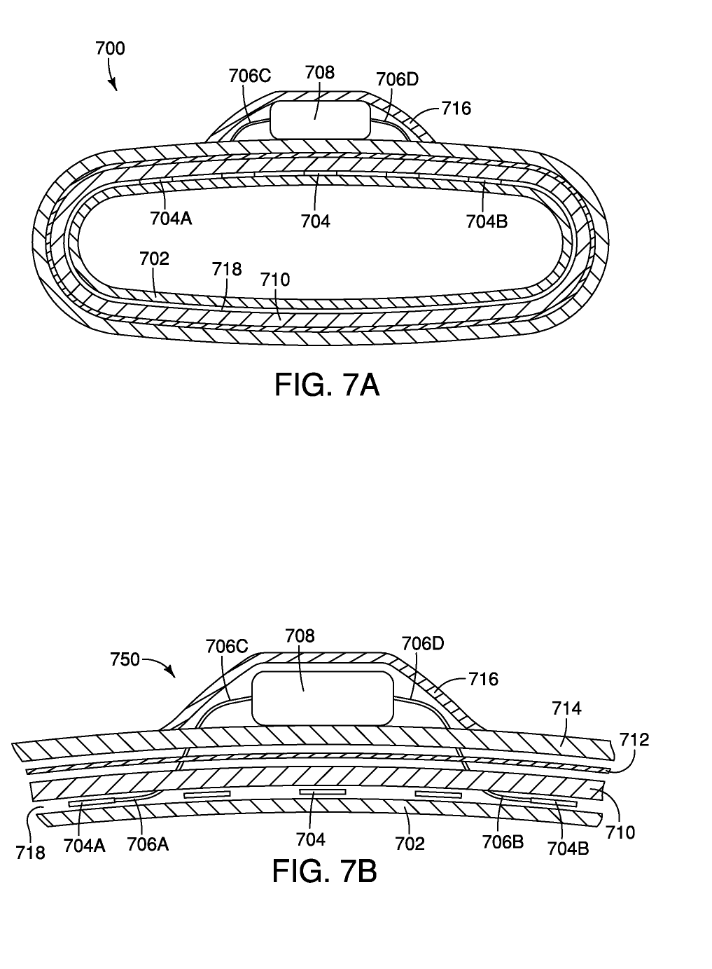

FIGS. 7A and 7B illustrate by way of example the structure of a heated glove. The primary structural component is an ordinary cold weather glove such as a ski glove or a hunting glove. The disclosed heating apparatus can be installed into any glove design and once configured properly is substantially transparent to the end user. Various type of textile materials (from nylon to fleece to leather) have been tested, along with most types of glove construction (straight cut palm, gun cut, etc.) with similar successful results.

FIG. 7A is a cut-away view of a heated glove 700. Such a heated glove 700 can be manufactured from the inside outward or the outside inward (depending upon other considerations). Typically, the construction of a heated glove begins with an inner liner 702. Outside of the inner liner 702 is typically an insulation layer 710. A void 718 is defined as the space between inner liner 702 and insulation layer 710. It is preferable to have additional layers (referenced in FIG. 7B) outside the insulation layer to provide further environmental protection of the insulation layer 710 and the ribbon element 704.

As previously noted, the ribbon element 704 is typically configured on the top of the hand (similar to that illustrated in FIG. 1). The ribbon element 704 (ribbon element 104 in FIG. 1) is configured so that it can run up to the tip of each finger, then double back upon itself. A stagger fold (122A, 122B and 122C in FIG. 1) or V fold (118A, 118B, 118C, 118D, 118E and 120 in FIG. 1) is advantageous to utilize so that the heating element can continue up to the adjacent finger. This pattern is repeated until all five fingers and the top of the hand are sufficiently covered.

Another method of routing a ribbon element within a heated glove comprises placing the ribbon element along the entire length of the glove's outer circumference, frequently known as the fourchette. The ribbon element typically starts on the outside edge of the palm and runs around an along the outside edge of each finger, terminating on the edge of the hand near the base of the thumb. If desirable in fourchette designs having an extra long linear length of ribbon element, remaining ribbon element can be placed on the top of the hand to provide additional heat.

Turning to FIG. 7B, a closer cut-away view of the layers of a heated glove 750 (similar to the heated glove 700) illustrates greater detail of the respective layers and components. More particularly, void 718 is more clearly visible with its proximate relationship to ribbon element 704. Outside the insulation layer 710, it is preferable to configure a waterproof layer 712 thereby obstructing environmental elements from reaching the insulation layer 710, ribbon element 704 and inner liner 702. Outside the waterproof layer 712, it is further desirable to configure an exterior layer 714 of durable fabric (e.g. rugged nylon) to resist wear and tear on the heated glove 750.

As further illustrated, end 704A of ribbon element 704 is coupled to a conduit in the proximity of 706A, thereby providing electrical communication to a power source 708 in the proximity of 706C. Similarly, end 704B of ribbon element 704 is coupled to a conduit in the proximity of 706B, thereby providing electrical communication to the power source 708 in the proximity of 706D. Similar to the exterior layer 714, it is preferable to configure a cover 716 to protect the power supply 708 from environmental elements. When electricity from power source 708 is transmitted through ribbon element 704, heat is generated and substantially contained inside insulation layer 710, thereby heating the inner liner 702.

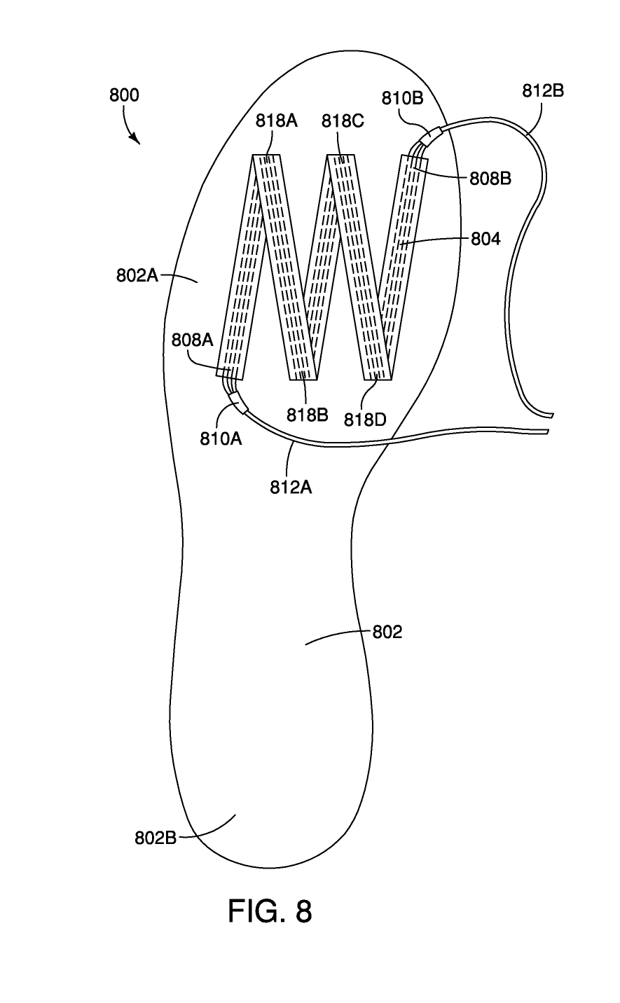

In FIG. 8, a heated footbed 800 is illustrated comprising of similar components of the previously disclosed heated glove of FIG. 1. More particularly, heated footbed 800 comprises an insole 802 having a toes end 802A and heel end 802B, with a ribbon element 804 preferably configured in the toes end 802B of the insole 802. As illustrated the ribbon element 804 is folded in several places 818A, 818B, 818C and 818D to cover a substantial surface area of the toes end 804A of the insole 804. Ribbon element 804 is coupled to a power source (not shown) through conduits 812A and 812B. It is preferable to utilize electrical connectors 810A and 810B to connect the ribbon element ends 808A and 808B, respectively, to conduits 812A and 812B. Utilization of such electrical connectors 810A and 810B (e.g. crimp style connectors, soldered connections or other conventional electrical connection) thereby provide a secure mechanical coupling and electrical communication.

In other embodiments of a heated footbed (not shown) it is preferable to configure the ribbon element along the circumference of the insole, and more particularly right along the circumference edge of the toes end of the insole to ensure heat transfer right to the edges of the heated footbed. As can be appreciated, the placement and folding of the ribbon element in various embodiments depends upon the desired heating sites as well as design and manufacturing considerations.

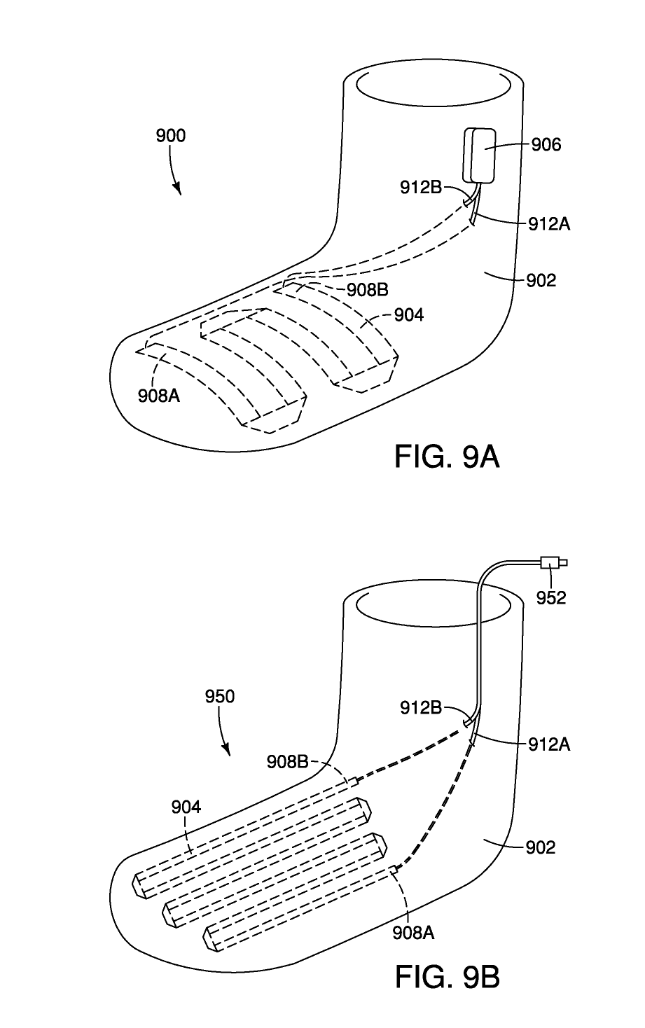

FIGS. 9A and 9B illustrate a heated sock 900 and a heated sock 950, respectively, comprising of generally similar components as the previously disclosed heated glove of FIG. 1 and heated footbed of FIG. 8. More particularly, heated sock 900 and heated sock 950 comprise a sock structure 902 with a ribbon element 904 coupled to conduits 912A and 912B.

It is further noted that ribbon element 904 can be situated on the top of the sock structure 902 as illustrated in FIGS. 9A and 9B, below the foot (not shown), around the circumference of the foot (not shown), or a combination thereof (not shown). As depicted in heated sock 950 in FIG. 9B, ribbon element 904 can be desirably configured to have a substantially longitudinal placement of ribbon element 904 rather than the substantially transverse placement of ribbon element 904 illustrated in FIG. 9A. Not unlike other embodiments of heated articles, the placement and direction of the ribbon element is dependent largely on the ribbon element design (e.g. number of conductive wires, resistance, etc.), length of the ribbon element, wiring scheme and power supply specifications.

Similar to other embodiments of the ribbon element disclosed earlier, heated sock 900 and heated sock 950 can be manufactured such that the ends 908A and 908B of ribbon element 904 connect directly (not shown) to a power source, thereby eliminating the need for conduits 912A and 912B. However, conduits 912A and 912B provide a desirable flexibility to locate a power source in a desired location such as a power source 906 situated above the ankle as illustrated in FIG. 9A.

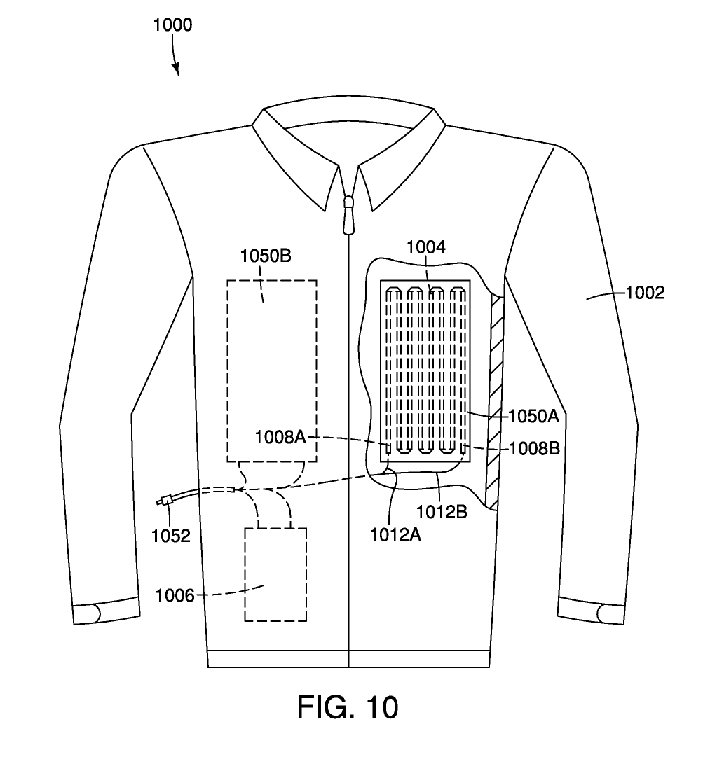

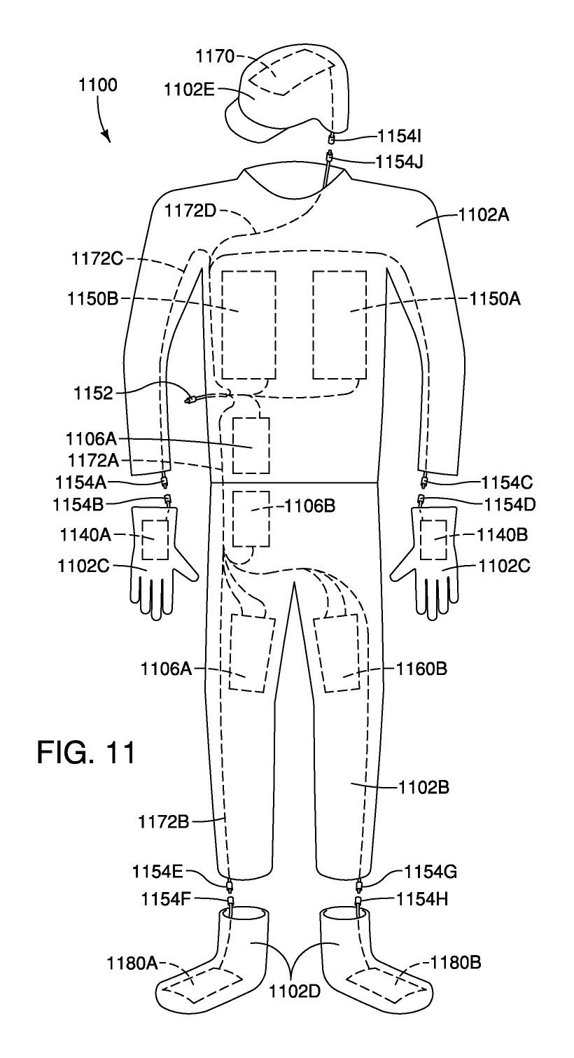

In FIG. 9B, conduits 912A and 912B are coupled to a power receptacle 952. Power receptacle 952 can comprise a quick disconnect style connecter as shown to ultimately couple to an external power source (not shown) that is not required to be in close proximity to heated sock 950. Examples of external power sources are further discussed in conjunction with FIGS. 10 and 11 (below).

FIG. 10 illustrates a heated jacket 1000 comprising of generally similar components as the previously disclosed heated glove of FIG. 1, heated footbed of FIG. 8 and heated socks of FIGS. 9A and 9B. More particularly, heated jacket 1000 comprises a jacket structure 1002 with ends 1008A and 1008B of a ribbon element 1004 coupled to conduits 1012A and 1012B, respectively. Conduits 1012A and 1012B are also coupled to power supply 1006 thereby supplying electricity to the ribbon element 1004.

As illustrated, conduits 1012A and 1012B are further coupled, in addition to power supply 1006, to an external power receptacle 1052. The external power receptacle 1052 as illustrated comprises a quick disconnect electrical connector intended to plug into a corresponding quick disconnect connector (not shown) in electrical communication with an external power source (not shown).

One example of such an external power source is a battery charger (not shown) suitable for charging power source 1006. It is further desirable that such a battery charger (not shown) could not only charge power source 1006 but simultaneously have the capacity to transmit electricity through the ribbon element 1004 rendering the heated jacket 1000 operational during charging. Other examples (not shown) of such an external power source comprise convenient direct current power sources such as an automobile 12V power source (e.g. cigarette lighter) or a power harness configured in an aircraft cockpit. Likewise, cell phone chargers or other common electronic power supplies can be configured as a suitable external power source.

As further illustrated in FIG. 11, a heating panel 1050A is comprised of heating ribbon 1004 and conduits 1012A and 1012B, representing a modular approach to heat generation in garments. Other heating panels such as a heating panel 1050B can be configured as desirable in any given garment or equipment application. Here, heating panel 1050A is situated on one side of the front of the jacket structure 1002, while heating panel 1050B is correspondingly situated on the other side of the front of the jacket structure 1002. Other heated panels (not shown) can be configured as desired in other locations of the jacket structure 1002 such as the back or shoulder areas.

While heating panel 1050A is illustrated to have a substantially vertical configuration of the ribbon element 1004 with a pattern similar to other embodiments disclosed. Alternatively, ribbon element 1004 can also be configured to have a substantially horizontal configuration of the ribbon element (not shown), or other orientation and pattern, to fit and optimize the ribbon element 1004 into the desired area for heating.

During the manufacturing process, heating panels 1050A and 1050B can be manufactured independent of the jacket structure 1002, thereby enjoying supply and cost efficiencies if desirable. With minimal installation procedures, namely inserting and securing (e.g. Velcro attachment, stitching, adhesive, stapling, rivoting, clipped, etc.) the heated panels 1050A and 1050B into the jacket structure 1002, practically any garment or equipment can be configured with a heating apparatus.

If several articles of clothing or articles of equipment are anticipated to be manufactured, it is preferable to design standard heating panels (such as heating panels 1050A and 1050B) and standard power sources (such as power source 1006) having standardized combinations thereof. Standardization of such combined components of heating apparatus significantly aids in the new design of heated articles of clothing and heated articles of equipment, since the requirement for complex electrical calculations and testing with each new article developed and manufactured can be minimized. An approach to such standardization of components is shown in FIG. 11.

FIG. 11 illustrates a heated clothing system 1100 comprising of various heated articles of clothing such as a heated shirtwear 1102A, a heated legwear 1102B, a heated handwear 1102C, a heated footwear 1102D and a heated headwear 1102E. Generally speaking, the various heated articles of clothing illustrated follow configurations previously discussed in other illustrations and descriptions of heated articles of clothing.

More particularly, heated shirtwear 1102A substantially parallels the jacket design previously discussed in FIG. 10, with a heating panel 1150A and a heating panel 1150B both coupled to a power source 1106A, all of which are further coupled to a power receptacle 1152. Likewise, heated legwear 1102B is similarly configured to heated shirtwear 1102A, comprising of a heating panel 1160A and a heating panel 1160B, each situated on the thighs of the heated legwear and each coupled to a power source 1106B. Heated handwear 1102C comprises a heating panel 1140A coupled to a power receptacle 1154B and a heating panel 1140B coupled to a power receptacle 1154D. Heated footwear 1102D comprises a heated panel 1180A coupled to a power receptacle 1154F and a heated panel 1180B coupled to a power receptacle 1154H. Heated headwear 1102E comprises a heating panel 1170 coupled to power receptacle 11541 through conduit 1172D.

It is preferable that the heated clothing system 1100 is standardized and modular in nature, such that certain articles can be mixed and matched to other articles. For example, such a heated clothing system 1100 could alternatively comprise of only the heated shirtwear 1102A and the heated legwear 1102B but not the remaining heated articles of clothing.

When designing and manufacturing various heated articles of clothing and heated clothing systems, it can be further preferable to configure one or more conduits that provide power to various articles of clothing and the heating panels thereof. For example, in the heated clothing system 1100 illustrated, conduit 1172A is useful for providing electrical communication between heated shirtwear 1102A and heated legwear 1102B. The implementation of such conduits (such as conduit 1172A) can render benefits of implementing a centralized power source, (such as either power source 1106A or power 1106B providing electricity to multiple articles of clothing). Similarly, with the implementation of both power sources 1106A and 1106B and conduit 1172A, a redundant and longer lasting supply of power can be provided by both power sources 1106A and 1106B.

In such a configuration, it is further preferable to configure power receptacle 1152 to charge both power sources 1106A and 1106B at the same time from a single external connection point (power receptacle 1152). Preferably, such an external power source (not shown) can also provide sufficient electricity to operate heating panels 1150A, 1150B, 1160A and 1160B while power sources 1106A and 1106B are being charged. Similarly, additional conduits 1172B and 1172C can be configured to provide sufficient charging power or electric current to supply other heated articles of clothing such as heated handwear 1102C, heated footwear 1102D or heated headwear 1102E.

Where two heated articles of clothing are adjacent to one another and are in electrical communication with one another, it is preferable to utilize selectable connectors (e.g. quick disconnect electrical connections) such that the electrical communication can be easily detached and re-attached. As illustrated, heated handwear 1102C and heated headwear 1102E can be readily detached or re-attached to heated shirtwear 1102A through selectable connectors 1154A, 1154B, 1154C and 1154D and selectable connectors 11541 and 1154J, respectively. Likewise, heated footwear 1102D can be readily detached or re-attached to heated legwear 1102B through selectable connectors 1154E, 1154F, 1154G and 1154H.

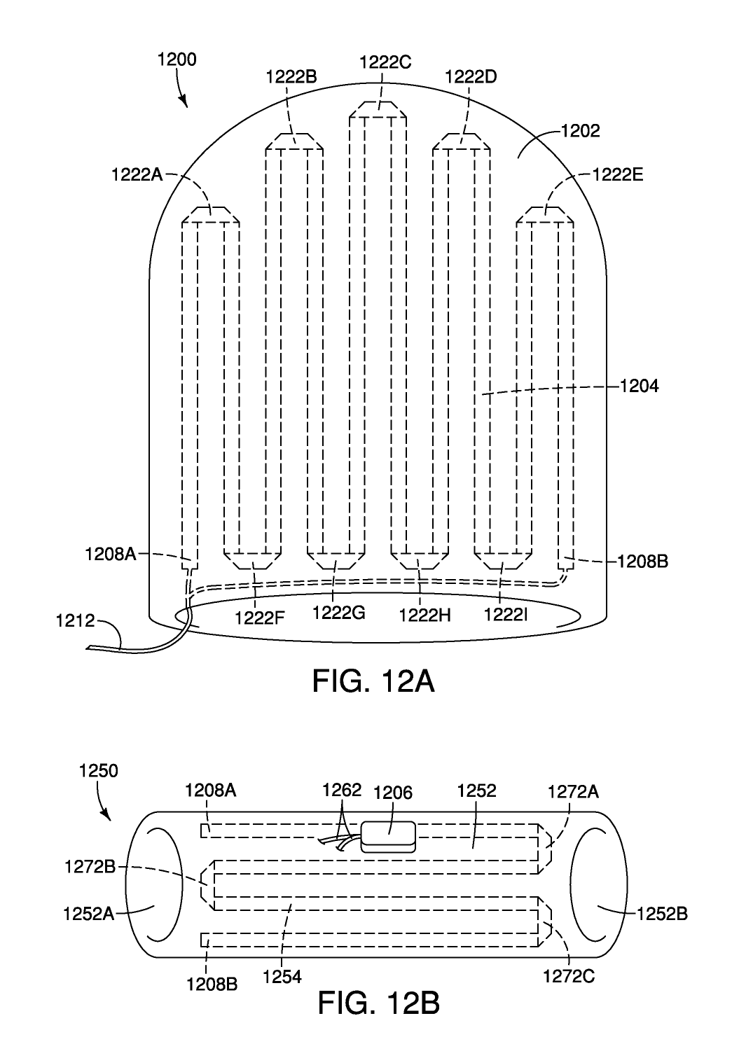

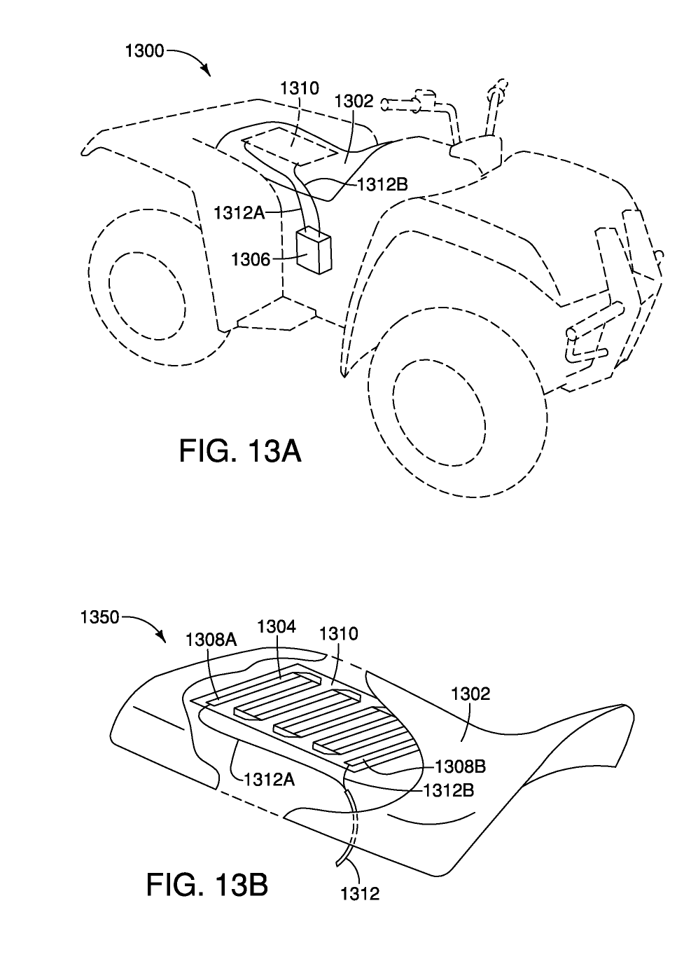

It is understood that depending upon the intended use and articles of clothing chosen, heated clothing systems disclosed can be manufactured as articles of clothing intended to be worn as a liner or underneath other articles (e.g. underwear), or alternatively can be manufactured as clothing worn on as outerwear (e.g. space suit, military uniform, hunting gear, etc.). In this regard, the heated clothing system 1100 and heated articles of clothing and articles of equipment illustrated herein utilizing a ribbon element are not restricted to any particular environment, usage or function. For example, FIGS. 12A, 12B and 13 exhibit other diverse embodiments of the present invention in the context of sports and recreational equipment.

FIG. 12A illustrates a heated mitt 1200, an electrically heated version of a traditional warming mitt used by professional football linemen in cold weather. Heated mitt 1200 generally follows the topics disclosed of the heated glove of FIG. 1, the heated footbed of FIG. 8, the heated socks of FIGS. 9A and 9B and the heated shirt of FIG. 10. More particularly, heated mitt 1200 comprises a mitt structure 1202 with ends 1208A and 1208B of a ribbon element 1204 coupled to an external power source (not shown) through one or more conduits 1212. Utilizing folds 1222A, 1222B, 1222C, 1222C, 1222D, 1222E, 1222F, 1222G, 1222H and 12221, a substantial portion of the heated mitt 1200 is covered by the ribbon element 1204 and therefore provided with heat. As noted in earlier discussions, such a ribbon element 1204 could be configured in alternate orientations or patterns (e.g. circumferential rather than parallel routing, horizontal rather than vertical pattern, etc.) depending upon the particular application.

FIG. 12B illustrates a heated handwarmer 1250, an electric heated version of a traditional handwarmer used on the uniform of professional football quarterback in cold weather. Heated handwarmer 1250 generally follows the topics disclosed of the heated glove of FIG. 1, the heated footbed of FIG. 8, the heated socks of FIGS. 9A and 9B, the heated shirt of FIG. 10 and the heated mitt of FIG. 12A. More particularly, heated handwarmer 1250 comprises a tubular structure 1252 having openings 1252A and 1252B. Openings 1252A and 1252B are intended for a human hand (not shown) to be inserted at each opening thereof for a brief period of time to exchange heat between the inserted hand and the heated handwarmer 1250 or between the hands thereof.

As this article of equipment is typically worn on the front or back of a football quarterback's uniform, it is of significant advantage to utilize a ribbon element 1254 for heating purposes rather than traditional prior art heating apparatus that is typically more bulky, heavier and less flexible. Ends 1208A and 1208B of the ribbon element 1250 in FIG. 12B are preferably electrically coupled to power source 1206 with one or more conduits 1262. Such a power source could also be an external receptacle (not shown) as disclosed in earlier discussed embodiments.

The ribbon element 1254 is preferably configured in a manner such as that illustrated with a horizontal parallel pattern to minimize weight, maximize flexibility and maximize durability. In this regard, the ribbon element 1254 can utilize folds 1272A, 1272B and 1272C to afford the maximum coverage across the length of the heated handwarmer 1250. In a like fashion to other articles and discussions above, the ribbon element 1204 could be configured in alternate orientations or patterns (e.g. wrapped around the inner or outer circumference of the tubular structure 1252, etc.) depending upon the desired location of heat generation.

FIG. 13A illustrates a heated seat 1300 for an all terrain vehicle. Discussion and design of the heated seat 1300 generally follows the embodiments previously discussed. The heated seat comprises a seat structure 1302 having a heating panel 1310 contained within or secured to seat structure 1302. Heating panel 1310 is electrically coupled to a power source 1306 (e.g. a standard 12V motorcycle battery) through conduits 1312A and 1312B. While not illustrated, switches or other controls (not shown) can be configured in conduits 1312A or 1312B to control the transmission of electricity through the heating panel 1310.

Turning to FIG. 13B, a heated seat 1350 is illustrated, providing a closer view of a similar heated seat 1300 of FIG. 13A. Heated panel 1310 is comprised of a ribbon element 1304 that is electrically coupled to one or more conduits 1312 at ends 1308A and 1308B of the ribbon element 1304. The ribbon element 1254 is preferably configured in a transverse parallel pattern thereby absorbing the typical forces exerted on such a seat structure 1302. However, the ribbon element 1304 could be configured in alternate orientations or patterns (e.g. a longitudinal parallel pattern or a circumferential pattern, etc.) depending upon the desired location of heat generation.

As can be appreciated, automotive, rail, boat or aircraft seats, along with other seats, can be readily retrofitted or manufactured to include the above disclosed ribbon element and heating apparatus technologies. Portable cushions and seats (e.g. stadium seat cushions) and other also make excellent structures to incorporate the heat apparatus disclosed herein. The ribbon element and heating apparatus technologies can also be utilized in furniture (e.g. heated sofa), office furniture (e.g. heated chair) or practically any physical structures (e.g. heated pipes, critical devices, etc.) in need of heat or otherwise in need of prevention of freezing. For further detail, the Examples section (below) of this technical disclosure will now disclose specific specifications of certain embodiments.

### CASE EXAMPLES

A pair of heated gloves utilizing the heating apparatus 200 of FIG. 2 can be configured utilizing 55″ of ribbon element, wherein the ribbon element comprises six conductive wires of high fiber count wired in a parallel circuit. A single 2-cell lithium battery for each glove rated at 7.4 volts and 2200 mAh has been found to be sufficient as a power source for a single glove. To charge a single lithium battery, an external power source with an output rating of 8.4 volts at 0.5 amperes has been found sufficient to fully charge the single lithium battery in a period of three hours or less. When in operation, such a lithium ion battery power source renders electricity sufficient to heat a glove for a period of three hours at 100% power output, six hours at 50% power output and 12 hours at 25% power output.

A football lineman mitt similar to the heated mitt described in FIG. 12A was recently tested with the cooperation of the Seattle Seahawks professional football team, wherein the effective ribbon element length was 55 inches and the ribbon element utilized five conductive wires of high fiber count wired in a parallel circuit. This heating apparatus was designed for 7.2 volt operation at 0.8 amperes.

Additional specifications and operational details for standardized heating panels, articles of clothing and other embodiments can be found within the content of the provisional applications as recited in the first paragraph of this technical disclosure.

### CONCLUSION

The novel approaches described herein for a ribbon element and its design and manufacture thereof, and heating apparatus incorporating such a ribbon element, provide several advantages over prior approaches. Embodiments of the present invention provide one or more of the desirable features of reduced weight, increased flexibility, increased durability and increased standardization in the design, manufacture and use of heated articles of clothing and heated articles of equipment. In the foregoing specification, the invention has been described as applicable to heating applications, where the special advantages of the apparatus are very desirable. However the same invention may be applied to other needs where the transmission of electricity is desired, such as power transport or data transmission.

Unless otherwise indicated, all numbers expressing quantities of ingredients, properties such as molecular weight, reaction conditions, and so forth used in the specification and claims are to be understood as being modified in all instances by the term “about” or “approximately.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The terms “a” and “an” and “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments of this invention are described herein, including the best mode known to the inventors for carrying out the invention. Of course, variations on those preferred embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. An improved heating apparatus comprising:
a ribbon element, the ribbon element further comprising of one or more conductive wires woven into a carrier strip, the one or more conductive wires further comprising of a high number of strands; and,
a power source coupled to the one or more conductive wires of the ribbon element, wherein the ribbon element generates heat upon the transmission of electricity through the one or more conductive wires.

2. The improved heating apparatus of claim 1, wherein the high number of strands is at least 16 fibers.

3. The improved heating apparatus of claim 1, wherein the high number of strands is at least 100 fibers.

4. The improved heating apparatus of claim 1, wherein the high number of strands comprises stainless steel material.

5. The improved heating apparatus of claim 1, wherein the high number of strands is at least 16 stainless steel fibers.

6. The improved heating apparatus of claim 1, wherein the high number of strands is at least 100 stainless steel fibers.

7. The improved heating apparatus of claim 1, wherein at least one of the one or more conductive wires are coated thereby providing mechanical and electrical insulation from the environment.

8. The improved heating apparatus of claim 1, wherein the carrier strip is comprised of an industry standard textile tape wherein the width of the carrier strip is between 0.25 inches and 2.0 inches, wherein the carrier strip comprises at least one marker running along the length of the carrier strip, and wherein the carrier strip further comprises nylon or polyester material.

9. The improved heating apparatus of claim 1, wherein the power source comprises at least one from the group consisting of: a rechargeable battery, a non-rechargeable battery, a power receptacle, a direct current electric source and an alternating current electric source.

10. The improved heating apparatus of claim 1, wherein the power source comprises a rechargeable lithium ion battery, a switch to selectively control the transmission of electricity from the power source and a meter to display the status of the power source.

11. The improved heating apparatus of claim 1, wherein the power source comprises a power source having a voltage between 7.0 and 7.5 volts.

12. The improved heating apparatus of claim 1, wherein the power source comprises a power source having a voltage between 11 and 15 volts.

13. The improved heating apparatus of claim 1, wherein the power source comprises a power source having a voltage between 22 and 28 volts.

14. The improved heating apparatus of claim 1, wherein the one or more conductive wires comprises at least five conductive wires.

15. The improved heating apparatus of claim 1, wherein the one or more conductive wires comprises at least five conductive wires, and wherein at least five of the one or more conductive wires of the ribbon element are coupled to the power source.

16. The improved heating apparatus of claim 1, wherein not all of the conductive wires of the ribbon element are coupled to the power source.

17. The improved heating apparatus of claim 1, wherein the one or more conductive wires comprises at least two conductive wires configured in a parallel circuit.

18. The improved heating apparatus of claim 1, wherein the improved heating apparatus is incorporated into one from the set consisting of: a glove, a sock, an insole, a vest, a jacket, a shirt, a pair of pants, a hat and a seat.

19. An improved article of clothing or equipment comprising:
a ribbon element incorporated into an article of clothing or equipment, the ribbon element comprising of five or more conductive wires woven into a carrier strip, wherein the carrier strip is of a standard textile tape having a width between 0.25 inches and 2.0 inches, wherein the five or more conductive wires comprise of at least six stainless steel strands each, and wherein the ribbon element generates heat upon the transmission of electricity through the five or more conductive wires; and,
a battery power source, selectively coupled to the five or more conductive wires of the ribbon element, thereby providing selective transmission of electricity through the ribbon element and generation of heat by the ribbon element.

20. The improved article of clothing or equipment of claim 19, wherein the at least six stainless steel strands is at least 16 stainless steel fibers.

21. The improved article of clothing or equipment of claim 19, wherein the at least six stainless steel strands is at least 100 stainless steel fibers.

22. The improved article of clothing or equipment of claim 19, wherein the five or more conductive wires of the ribbon element are configured in a parallel circuit.

23. The improved article of clothing or equipment of claim 19, wherein the battery power source is a rechargeable battery having a voltage from 7.0 to 7.5 volts.

24. The improved article of clothing or equipment of claim 19, wherein the ribbon element comprises a plurality of ribbon elements.

25. The improved article of clothing or equipment of claim 19, wherein the article of clothing or equipment is one from the set consisting of: a heated glove, a heated shirt, a heated vest, a heated jacket, a heated sock, a heated insole, a heated hat and a heated seat.

26. The improved article of clothing or equipment of claim 19, wherein the article of clothing or equipment is one from the set consisting of: a heated glove, a heated shirt, a heated vest, a heated jacket, a heated sock, a heated insole, a heated hat and a heated seat.

27. A heated glove, comprising:
a ribbon element situated between an inner liner and exterior layer of the heated glove, wherein the ribbon element comprises ten or more folds such that the ribbon element is situated along the top of the fingers and top of the hand portions of the inner liner, and wherein the ribbon element further comprising of five or more conductive wires woven into a carrier strip having a width between 0.25 inches and 0.75 inches, wherein the five or more conductive wires further comprising of at least six stainless steel strands each; and,
a lithium ion rechargeable battery power source having a voltage of 7.0 to 7.5 volts, wherein the lithium ion rechargeable battery power source comprises a switch to selectively control the transmission of electricity from the power source and a meter to display a status of the power source;
wherein the lithium ion rechargeable battery power source is selectively coupled to the five or more conductive wires of the ribbon element in a parallel circuit, thereby providing selective transmission of electricity causing a corresponding selective generation of heat.

28. An improved method of producing a heating apparatus, comprising:
providing three or more conductive wires, wherein each of the three or more conductive wires comprising at least six strands;
weaving the three or more conductive wires into a carrier strip to form a ribbon element; and,
coupling the three or more conductive wires of the ribbon element to a power source, thereby providing electrical communication between the ribbon element and the power source for the transmission of electricity through the three or more conductive wires and generation of heat by the ribbon element.

29. The improved method of producing a heating apparatus of claim 28, further comprising the step of:
incorporating the ribbon element and power source into an article of clothing or equipment.

30. An improved method of producing a heated glove, comprising:
providing five or more conductive wires, wherein each of the five or more conductive wires comprises at least six stainless steel strands each;
weaving the five or more conductive wires into a carrier strip to form a ribbon element, wherein the carrier strip comprising a width between 0.025 inches to 0.75 inches;
providing a rechargeable battery power source having a voltage between 7.0 and 7.5 volts, wherein the power source comprises a switch to selectively control the transmission of electricity from the power source and a meter to display a status of the power source;
providing an inner layer, an insulation layer, a waterproof layer and an exterior layer of a glove;
attaching the ribbon element to the inner liner, wherein the ribbon element is situated along the top of the fingers and hand utilizing ten or more folds of the ribbon element;
configuring an insulation layer around the ribbon element and inner liner;
configuring a waterproof layer around the insulation layer;
configuring an exterior layer to contain the waterproof layer, the insulation layer, the ribbon element and the inner liner within the exterior layer; and
coupling the five or more conductive wires of the ribbon element to the power source as a parallel circuit thereby providing for selective transmission of electricity and generation of heat.
